(19) United States
(12) Patent Application Publication
(10) Pub. No.: US 2026/0328401 A1
(43) Pub. Date: Oct. 22, 2026

(54) COOKING APPARATUS AND METHOD OF CONTROLLING THE COOKING APPARATUS

(71) Applicant: SAMSUNG ELECTRONICS CO., LTD., Suwon-si (KR)

(72) Inventors: Jaeseok LEE, Suwon-si (KR); Sanghyun YEO, Suwon-si (KR); Sunghoo LEE, Suwon-si (KR); Jaegyeong MA, Suwon-si (KR); Kilyoung LEE, Suwon-si (KR)

(73) Assignee: SAMSUNG ELECTRONICS CO., LTD., Suwon-si (KR)

(21) Appl. No.: 19/529,494

(22) Filed: Feb. 4, 2026

Related U.S. Application Data
(63) Continuation of application No. PCT/KR2025/017289, filed on Oct. 28, 2025.

(30) Foreign Application Priority Data
Nov. 6, 2024 (KR) 10-2024-0156489

(51) Int. Cl. F24C 15/20; F24C 15/02; F24C 15/32

(52) U.S. Cl. CPC F24C 15/2021; F24C 15/022; F24C 15/2007; F24C 15/322

(57) ABSTRACT

A cooking apparatus may include: a main body; a cooking room inside the main body; a door configured to open and close to respectively open and close the cooking room, the door including a door duct having a discharge hole through which air inside the door is dischargeable to outside of the door; and a controller configured to: based on an internal temperature of the cooking room being greater than or equal to a temperature, open the discharge hole such that the air inside the door is dischargeable to the outside of the door, and based on the internal temperature being less than the temperature, close the discharge hole such that the air inside the door is prevented from being discharged to the outside of the door.

### CROSS-REFERENCE TO RELATED APPLICATIONS

This is a continuation application, under 35 U.S.C. § 111(a), of International Application No. PCT/KR 2025/017289, filed Oct. 28, 2025, which claims priority under 35 U.S.C. § 119 to Korean Patent Application No. 10-2024-0156489, filed Nov. 6, 2024, in the Korean Intellectual Property Office, the disclosures of which are incorporated herein in their entireties by reference.

### TECHNICAL FIELD

The present disclosure relates to a cooking apparatus and a method of controlling the cooking apparatus.

### BACKGROUND ART

In general, a cooking apparatus is an appliance including a cooking room, a heater for applying heat to the cooking room, and a circulation fan for circulating heat generated by the heater inside the cooking room to cook food.

The cooking apparatus is an appliance for cooking food by sealing and heating the food. Cooking apparatuses are generally classified into an electric type, a gas type, and an electronic type according to their heat sources. An electric oven uses an electric heater as a heating source, and a gas oven and a microwave use heat generated by gas and frictional heat of water molecules caused by high frequency as heating sources, respectively.

In general, the cooking apparatus includes a main body which forms an appearance and of which the front side opens to form a cooking room for accommodating food to be cooked therein, and a door mounted on the front side of the main body to selectively open or close the cooking room.

The door is made of a plurality of glasses to prevent heat inside the cooking room from leaking out. Because the temperature of the door rises by heat from the cooking room, the door includes an air inlet into which outside air is sucked to prevent the door from rising in temperature, and air sucked into the air inlet circulates along an air flow path formed between the plurality of glasses to be lowered in temperature and then is discharged to the outside of the door.

In general, in order to lower the temperature of the outer surface of the door, a cooling structure based on the Venturi effect is used to discharge high-temperature air inside the door to the outside of the door, or a cooling fan is used to forcibly suck high-temperature air inside the door and then discharge the air to the outside of the door.

### DISCLOSURE

### Technical Problem

The disclosure provides a cooking apparatus capable of opening or closing a discharge hole of a door duct according to a temperature of a cooking room to discharge high-temperature air inside a door to outside of the door, and a method of controlling the cooking apparatus.

The technical object intended to be achieved by the present document is not limited to the above-mentioned technical objects, and other technical objects not mentioned will be clearly understood by one of ordinary skill in the technical art to which the disclosure belongs from the following description.

### Technical Solution

In accordance with the present disclosure, a cooking apparatus may include: a main body; a cooking room inside the main body; a door configured to open and close to respectively open and close the cooking room, the door including a door duct having a discharge hole through which air inside the door is dischargeable to outside of the door; and a controller configured to: based on an internal temperature of the cooking room being greater than or equal to a temperature, open the discharge hole such that the air inside the door is dischargeable to the outside of the door, and based on the internal temperature being less than the temperature, close the discharge hole such that the air inside the door is prevented from being discharged to the outside of the door.

In accordance with the present disclosure, a method of controlling a cooking apparatus including a main body, a cooking room inside the main body, a door configured to open and close to respectively open and close the cooking room, the door including a door duct having a discharge hole through which air inside the door is dischargeable to outside of the door, and a controller, may include: by the controller, detecting an internal temperature of the cooking room, based on the internal temperature being greater than or equal to a temperature, opening the discharge hole such that the air inside the door is dischargeable to the outside of the door, and based on the internal temperature being less than the temperature, closing the discharge hole such that the air inside the door is prevented from being discharged to the outside of the door.

### DESCRIPTION OF DRAWINGS

FIG. 1 is a perspective view of a cooking apparatus according to an embodiment.

FIG. 2 shows a state in which a door of a cooking apparatus according to an embodiment opens.

FIG. 3 is a side cross-sectional view of a cooking apparatus according to an embodiment.

FIG. 4 shows a door locking device of a cooking apparatus according to an embodiment.

FIG. 5 shows a situation in which high-temperature air inside a door is discharged to outside of the door through inlet passages and exhaust passages of a cooking apparatus according to an embodiment.

FIG. 6 shows a door unlocked state of a cooking apparatus according to an embodiment.

FIG. 7 shows a discharge hole closed by an opening/closing device of a cooking apparatus according to an embodiment.

FIG. 8 shows a situation in which high-temperature air inside a door is prevented from being discharged to outside of a cooking apparatus according to an embodiment while a discharge hole is closed by an opening/closing device of the cooking apparatus.

FIG. 9 shows a door locked state of a cooking apparatus according to an embodiment.

FIG. 10 shows a discharge hole opened by an opening/closing device of a cooking apparatus according to an embodiment.

FIG. 11 shows a flow of air by which high-temperature air inside a door is discharged to outside of a cooking apparatus according to an embodiment while a discharge hole is opened by an opening/closing device of the cooking apparatus.

FIG. 12 is a control block diagram of a cooking apparatus according to an embodiment.

FIG. 13 shows an example of a flowchart illustrating a method of controlling a cooking apparatus according to an embodiment.

FIG. 14 shows an example of a flowchart illustrating a method of opening or closing a discharge hole of a door duct based on a temperature of a cooking room in a cleaning course of a cooking apparatus according to an embodiment.

FIG. 15 shows changes in room temperature while a discharge hole of a door duct is opened/closed in a cooking apparatus according to an embodiment.

FIG. 16 shows an example of a flowchart illustrating a method of opening or closing a discharge hole of a door duct based on a temperature of a cooking room in a cooking course of a cooking apparatus according to an embodiment.

FIG. 17 shows an example of a flowchart illustrating a method of controlling Revolutions Per Minute (RPM) of a cooling fan based on a temperature of a printed circuit board while a cooking apparatus according to an embodiment operates.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1^{st}”, “2^{nd}”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that the component can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a certain component is referred to as being “on” or “over” another component, it can be directly on the other component or intervening components may also be present.

Hereinafter, an embodiment of the disclosure will be described in detail with reference to the accompanying drawings.

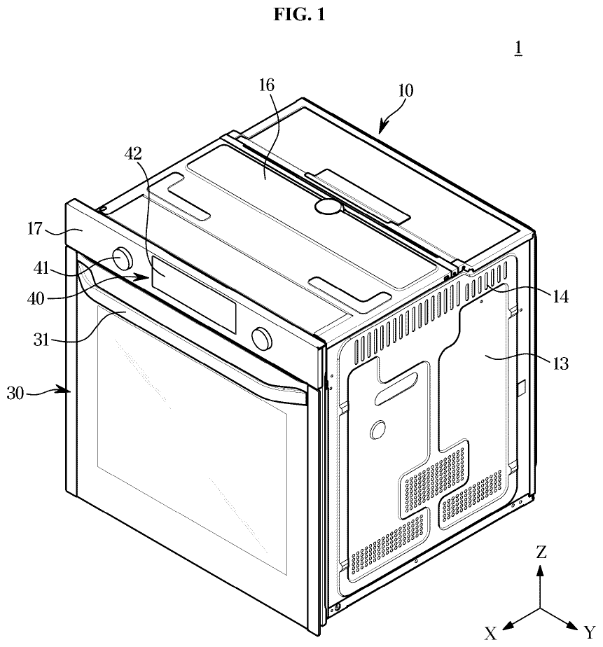

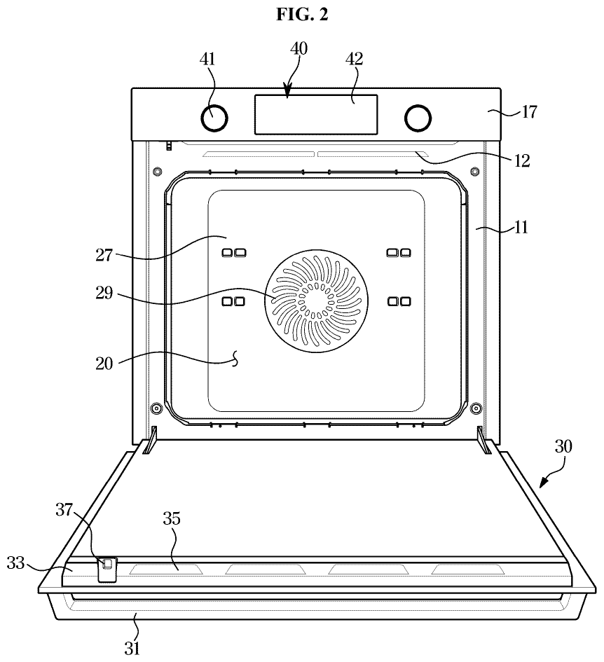

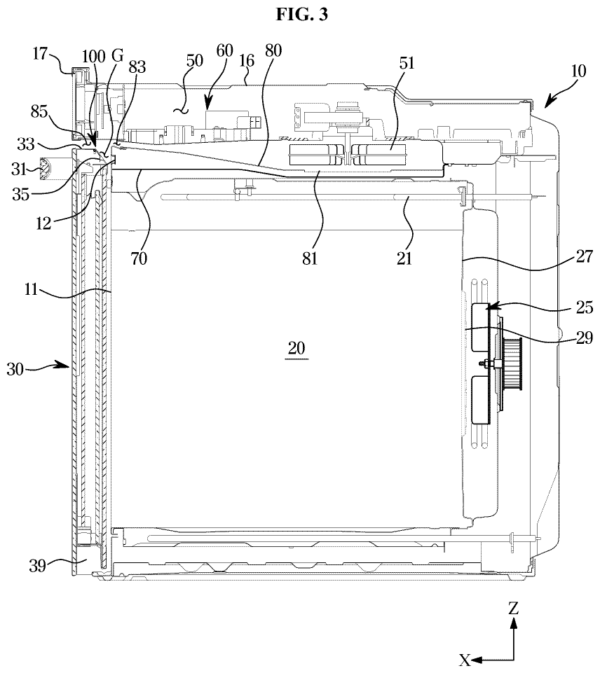

FIG. 1 is a perspective view of a cooking apparatus according to an embodiment. FIG. 2 shows a state in which a door of a cooking apparatus according to an embodiment opens. FIG. 3 is a side cross-sectional view of a cooking apparatus according to an embodiment.

Referring to FIGS. 1, 2, and 3, a cooking apparatus 1 may include a main body 10 forming an appearance, a cooking room 20 which is formed inside the main body 10 and of which a front side opens, and a door 30 mounted on the front side of the main body 10 to open or close the cooking room 20.

The main body 10 may include a front panel 11 forming the front side of the main body 10, a side panel 13 forming a lateral side of the main body 10, a rear panel 15 forming a rear side of the main body 10, and an upper panel 16 forming an upper side of the main body 10.

A machine room cover 17 may be positioned above a front side of the front panel 11 to cover a front side of a machine room 50. A user interface 40 may be mounted on the machine room cover 17.

The front panel 11 may be provided with an inlet hole 12 into which high-temperature air discharged from inside of the door 30 is sucked. A configuration in which the front panel 11 is provided with the inlet hole 12 will be described in detail below.

The side panel 13 may be provided with an inlet portion 14 through which air is sucked into the machine room 50. Outside air sucked into the machine room 50 through the inlet portion 14 may flow inside the machine room 50 to cool electronic components.

The cooking room 20 may be formed inside the main body 10 and have a box shape of which a front side opens. A cooking material may be put into or taken out of the cooking room 20 through the open front side of the cooking room 20.

A plurality of supports may be provided on both inner side walls of the cooking room 20, and a rack on which a cooking material is placed may be mounted on the plurality of supports.

A divider for partitioning the cooking room 20 into a plurality of cooking rooms 20 may be detachably mounted on the plurality of supports. The plurality of cooking rooms 20 partitioned by the divider may not need to have the same size and may have different sizes. The divider may be made of an insulating material to insulate the cooking rooms 20 from each other. Therefore, a plurality of partitioned spaces of the cooking room 20 may be used in various ways according to a user's intention.

In the cooking room 20, a heater 21 for heating a cooking material may be provided. The heater 21 may be, but is not limited to, an electric heater including an electric resistance element. However, the heater 21 may be a gas heater that generates heat by burning gas. Accordingly, the cooking apparatus 1 may include an electric oven and a gas oven.

In a rear portion of the cooking room 20, a circulation fan 25 for circulating air of the cooking room 20 to uniformly heat a cooking material may be installed.

A fan cover 27 may be positioned in front of the circulation fan 25 to cover the circulation fan 25. In the fan cover 27, a through hole 29 may be formed to allow air to pass through.

The open front side of the cooking room 20 may be opened or closed by the door 30. The door 30 may be hinge-coupled to a lower portion of the main body 10 to be rotatable relative to the main body 10. In a front upper portion of the door 30, a door handle 31 may be provided which is gripped by a user. The user may open or close the cooking room 20 by gripping the door handle 31. A door duct 33 may be provided above the door 30. The door duct 33 may include a discharge hole 35 through which high-temperature air inside the door 30 is discharged to outside of the door 30. The door duct 33 may include a locking portion 37 that locks or unlocks the door 30. The discharge hole 35 and the locking portion 37 will be described in detail below. An air inlet 39 through which outside air is sucked into the inside of the door 30 may be provided in a lower portion of the door 30.

The user interface 40 that displays various operation information of the cooking apparatus 1 and allows a user to input an operation command may be mounted on the machine room cover 17 provided above the front side of the front panel 11. For example, the user interface 40 may include at least one input device 41 and a display 42.

In an embodiment, the at least one input device 41 may include a power button.

The power button may be a button for turning on/off the cooking apparatus 1 or various components of the cooking apparatus 1.

For example, the power button may be a button for turning on/off the display 42.

An example of the at least one input device 41 is not limited thereto, and any component capable of converting sensory information received from a user into an electrical signal may be adopted as the at least one input device 41.

According to the display 42 being implemented as a touch display, the display 42 may also be an example of the at least one input device 41.

The display 42 may include, for example, a Liquid Crystal Display (LCD) panel, an indicator, and a Light Emitting Diode (LED) panel.

According to an embodiment, the display 42 may be implemented as a touch pad, a touch screen, etc. to receive a user input.

The display 42 may display various screens for interactions between a user and the cooking apparatus 1.

The cooking apparatus 1 may include the machine room 50 that accommodates electronic components including the user interface 40. The machine room 50 may be provided above the cooking room 20. In the machine room 50, a Printed Circuit Board (PCB) on which circuit components are mounted or a Printed Board Assembly (PBA) including a PCB may be provided.

An insulation (not shown) that insulates between the machine room 50 and the cooking room 20 to prevent heat of the cooking room 20 from being transferred to the machine room 50 may be provided between the machine room 50 and the cooking room 20. The insulation may cover an entire outer side of the cooking apparatus 1, as well as a space between the machine room 50 and the cooking room 20, to prevent heat of the cooking room 20 from being transferred to outside of the cooking apparatus 1.

Because an internal space of the machine room 50 rises in temperature by heat from various electronic components, the cooking apparatus 1 may include a cooling structure for cooling the machine room 50 by circulating air around the machine room 50.

The cooling structure of the cooking apparatus 1 may include a cooling fan 51 that circulates air, and exhaust passages 80 and 85 that discharge air sucked in by the cooling fan 51 from the main body 10 in a front direction.

Outside air of the cooking apparatus 1 may be sucked into the machine room 50 through the inlet portion 14 formed in the side panel 13. Air sucked into the machine room 50 may circulate the inside of the machine room 50 to cool the electronic components and then be guided by the exhaust passages 80 and 85 to be discharged from the cooking apparatus 1 in the front direction.

In the machine room 50, a door locking device 60 for locking or unlocking the door 30 may be provided.

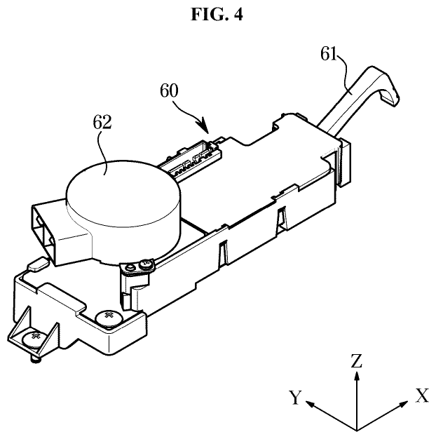

FIG. 4 shows a door locking device of a cooking apparatus according to an embodiment.

Referring to FIG. 4, the door locking device 60 may prevent the door 30 from being accidentally opened when the cooking apparatus 1 operates at a high temperature, thereby preventing burns or accidents. The door locking device 60 may be required for safety during an operation at a very high room temperature, such as during a cleaning course.

For example, the door locking device 60 may include a door locking switch 61 that is rotatable relative to the door locking device 60, and a door locking motor 62 that rotates the door locking switch 61.

The door locking switch 61 may be locked to or unlocked from the locking portion 37 provided in the door duct 33.

A rotating force of the door locking motor 62 may be transferred to the door locking switch 61 through a cam or a gear mechanism. The door locking switch 61 may have a hook shape and may be caught by the locking portion 37 of the door 30. While the door locking motor 62 rotates, the door locking switch 61 may move up and down.

While the door locking switch 61 is locked to the locking portion 37, the door 30 may be locked. While the door locking switch 61 is unlocked from the locking portion 37, the door 30 may be freely opened and closed.

In various embodiments, the door locking device 60 may include a linear actuator that rotates the door locking switch 61, instead of the door locking motor 62.

For example, the linear actuator may be powered by a relay. When the relay is turned on, power may be supplied to the linear actuator to cause a push rod to move from an initial position, and the door locking switch 61 connected to the push rod may be engaged with the door 30 to form a locked state. Also, when the relay is turned off, power to the linear actuator may be cut off to cause the push rod to return to the initial position, thereby releasing the door locking switch 61 from the door 30.

Hereinafter, for convenience of description, a case in which the door locking device 60 includes the door locking motor 62 that rotates the door locking switch 61 will be described.

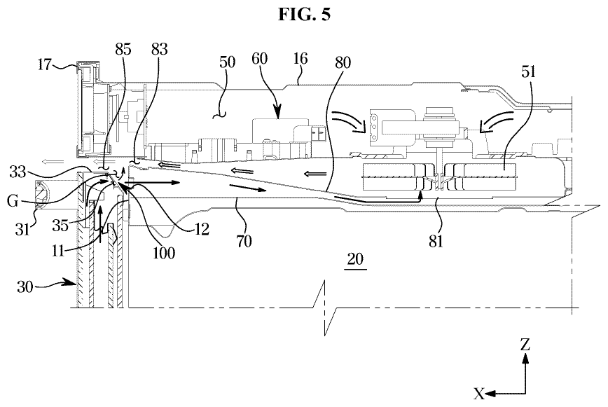

FIG. 5 shows a situation in which high-temperature air inside a door is discharged to outside of the door by inlet passages and exhaust passages of a cooking apparatus according to an embodiment.

Referring to FIG. 5, the cooling structure that discharges high-temperature air inside the door 30 to the outside of the door 30 may include inlet passages 35, 12 and 70 through which high-temperature air inside the door 30 is sucked in by the cooling fan 51, and the exhaust passages 80 and 85 through which high-temperature air sucked in by the cooling fan 51 is discharged to outside of the main body 10.

The inlet passages 35, 12 and 70 may include the discharge hole 35 provided in the door duct 33, the inlet hole 12 provided in the front panel 11, and an inlet duct 70 that communicates with the inlet hole 12 and guides air sucked into the inlet hole 12 to the cooling fan 51.

The cooling fan 51 may be provided in a shape capable of sucking air in both directions to suck outside air of the cooking apparatus 1 into the machine room 50 and suck in high-temperature air discharged from the inside of the door 30 through the inlet hole 12 and the inlet duct 70. That is, the cooling fan 51 may be provided in a shape capable of sucking in air from the upper and lower portions, respectively.

The exhaust passages 80 and 85 may include an exhaust duct 80 that guides air sucked in by the cooling fan 51 to be discharged to the outside of the main body 10, and an exhaust portion 85 that communicates with the exhaust duct 80 and discharges air to the outside of the main body 10. At an end of the exhaust duct 80 that communicates with the exhaust portion 85, an exhaust outlet 83 through which air of the exhaust duct 80 is discharged to the exhaust portion 85 may be provided.

The exhaust portion 85 may be formed between an upper end of the door duct 33 and the machine room 50. More specifically, the exhaust portion 85 may be formed above the door duct 33. The exhaust portion 85 may be formed below the machine room cover 17 covering a front side of the machine room 50 and a front portion of the machine room 50.

The upper end of the door duct 33 may be positioned between the inlet hole 12 and the exhaust outlet 83 of the exhaust duct 80. The reason may be to prevent air discharged from the discharge hole 35 and sucked into the inlet hole 12 from colliding with air discharged to the exhaust outlet 83.

A gap G may be formed between the door duct 33 provided with the discharge hole 35 for discharging high-temperature air inside the door 30 and the front panel 11 provided with the inlet hole 12 through which air discharged from the discharge hole 35 is sucked in. A part of high-temperature air discharged to the discharge hole 35 may be sucked into the inlet hole 12, and the remaining part may be discharged to the exhaust portion 85 through the gap G. Because the upper end of the door duct 33 is positioned between the inlet hole 12 and the exhaust outlet 83 of the exhaust duct 80, the remaining part of high-temperature air discharged to the discharge hole 35 may be smoothly discharged to the exhaust portion 85 through the gap G.

The door duct 33 may include an opening/closing device 100 that opens or closes the discharge hole 35 of the door duct 33. Details about the opening/closing device 100 will be described below.

Hereinafter, a flow of air by which high-temperature air inside the door 30 is discharged to the outside of the door 30 and the high-temperature air discharged to the outside of the door 30 is discharged to the outside of the cooking apparatus 1 will be described.

Air sucked into the air inlet 39 (see FIG. 3) provided in the lower portion of the door 30 may rise in temperature inside the door 30 and thus move upward. The air sucked into the air inlet 39 may rise in temperature while lowering a temperature of an outer surface of the door 30 raised by an internal temperature of the cooking room 20. High-temperature air inside the door 30 may move upward inside the door 30 and be discharged to the outside of the door 30 through the discharge hole 35. A part of the high-temperature air discharged through the discharge hole 35 may be forcibly sucked into the inlet hole 12 by the cooling fan 51. The high-temperature air sucked into the inlet hole 12 may be guided by the inlet duct 70 and sucked into the cooling fan 51. To cause the air guided by the inlet duct 70 to be sucked into the cooling fan 51, the exhaust duct 80 may include an inlet opening 81. The high-temperature air sucked into the cooling fan 51 may be guided by the exhaust duct 80 and discharged to the exhaust outlet 83. The high-temperature air discharged to the exhaust outlet 83 may be discharged to the outside of the cooking apparatus 1 through the exhaust portion 85.

The remaining part of the high-temperature air discharged to the discharge hole 35 may be discharged to the exhaust portion 85 through the gap G by the Venturi effect. Due to a flow rate of air discharged to the exhaust portion 85 by the cooling fan 51, a low-pressure region may be made in the exhaust portion 85. According to the low-pressure region being made in the exhaust portion 85, the high-temperature air discharged to the discharge hole 35 may be discharged to the exhaust portion 85 through the gap G that communicates with the exhaust portion 85. The high-temperature air discharged to the exhaust portion 85 may be discharged to the outside of the cooking apparatus 1.

Accordingly, high-temperature air inside the door 30 may be discharged to the outside of the main body 10 through at least one of a method based on the Venturi effect or a method based on forced suction by the cooling fan 51. Therefore, a capacity of the cooking room 20 may be ensured and a temperature of the outer surface of the door 30 may be efficiently lowered.

Generally, the cooking room 20 of the cooking apparatus 1 may adopt various kinds of insulations or insulating methods to prevent internal heat from leaking out as much as possible. A greatest function of the door 30 may ensure sealing to prevent internal heat from leaking out while allowing a user to check a cooling material inside the cooking apparatus 1 while the cooking apparatus 1 operates.

The door 30 may have the discharge hole 35 in the door duct 33 to discharge internal heat to the outside of the door 30 and maintain a temperature (for example, surface temperature) of an outermost glass below a certain level. The discharge hole 35 may function to maintain a surface temperature of the door 30 below a certain level during a cleaning course (for example, a Pyrolytic clean course) of cleaning the inside of the cooking apparatus 1 with high-temperature heat or during high-temperature cooking.

However, while the cooking apparatus 1 operates, a cooling flow path through the discharge hole 35 may influence a temperature of an inner glass of the door 30. For example, a difference between an internal temperature of glasses of the door 30 and an external temperature of the glasses may be about 30 °C or more. This may cause an increase of consumption power and influence a cooking material located close to the glasses.

The cooking apparatus 1 according to an embodiment of the disclosure may include the opening/closing device 100 that opens or closes the discharge hole 35 of the door duct 33, and open or close the discharge hole 35 through the opening/closing device 100 based on a temperature of the cooking room 20, thereby reducing heat loss generated through door cooling to improve energy efficiency of the cooking apparatus 1. That is, by closing the discharge hole 35 of the door duct 33 in a situation in which a temperature of the outer surface of the door 30 is not high, insulation of the door duct 33 may be improved to reduce energy loss inside the glasses of the door 30, thereby achieving energy saving and even cooking.

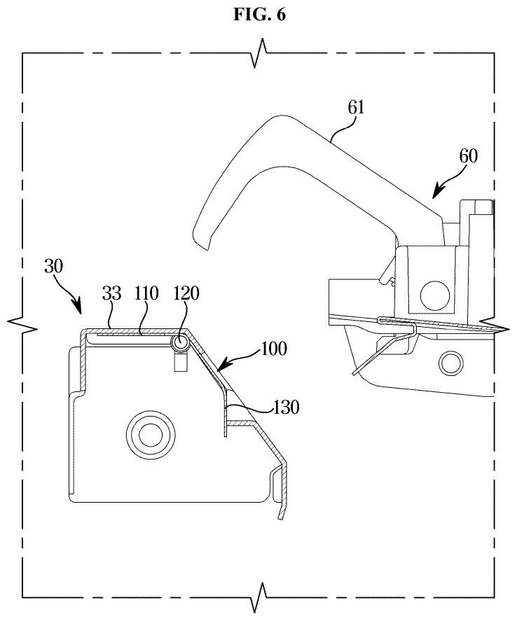

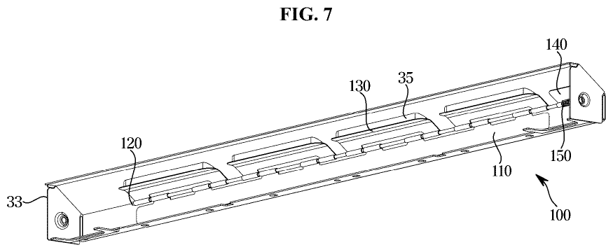

FIG. 6 shows a door unlocked state of a cooking apparatus according to an embodiment, and FIG. 7 shows a discharge hole closed by an opening/closing device of a cooking apparatus according to an embodiment.

Referring to FIGS. 6 and 7, the opening/closing device 100 may open or close the discharge hole 35 of the door duct 33.

The opening/closing device 100 may include a support 110 provided in the door duct 33, a rotating shaft 120 rotatably supported to the support 110, a cover 130 that rotates together with the rotating shaft 120 to open or close the discharge hole 35, a contact portion 140 provided on the rotating shaft 120 to contact or be release from the door locking switch 61 of the door locking device 60 to rotate the cover 130, and a torsion spring 150 provided in the contact portion 140.

The contact portion 140 may be provided on the rotating shaft 120 and contact the door locking switch 61. While the door locking device 60 is unlocked from the locking portion 37, the door locking switch 61 may be spaced from the contact portion 140. While the door locking device 60 is locked to the locking portion 37, the door locking switch 61 may be in contact with the contact portion 140.

According to the door locking device 60 being unlocked from the locking portion 37 and the door locking switch 61 being spaced from the contact portion 140, the cover 130 may be maintained in a closed state, which is an initial state, by a force from the torsion spring 150 that returns the cover 130 to an initial position. Accordingly, the discharge hole 35 of the door duct 33 may be maintained in a closed state which is an initial state.

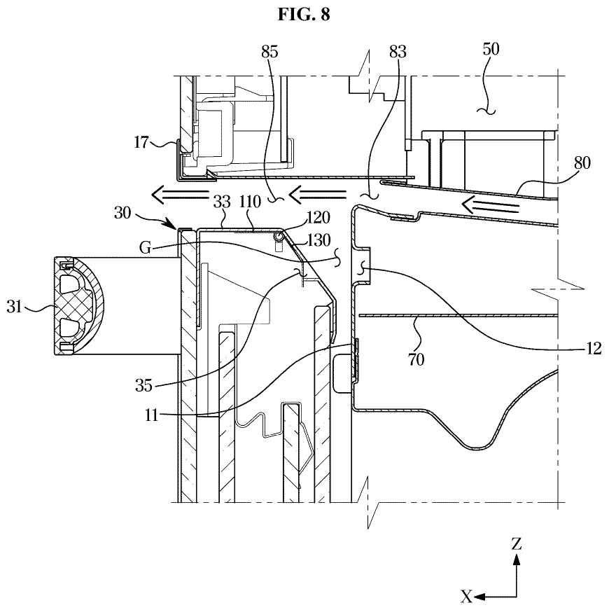

FIG. 8 shows a situation in which high-temperature air inside a door is prevented from being discharged to outside of a cooking apparatus according to an embodiment while a discharge hole is closed by an opening/closing device of the cooking apparatus.

FIG. 8 shows a state in which the door locking switch 61 is unlocked from the locking portion 37 while the cooking apparatus 1 operates. In this case, the door locking switch 61 may be spaced from the contact portion 140 and the cover 130 may close the discharge hole 35 of the door duct 33. While the discharge hole 35 is closed by the cover 130, high-temperature air inside the door 30 may be prevented from being discharged to the outside of the door 30. Accordingly, because high-temperature air inside the door 30 is prevented from being discharged to the outside of the door 30, energy loss may be reduced.

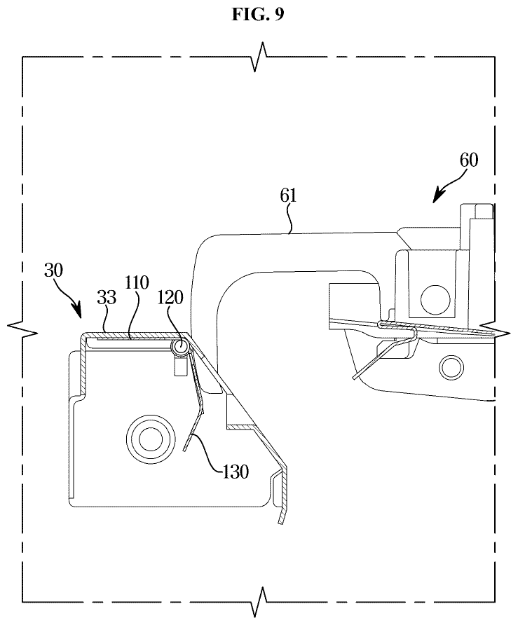

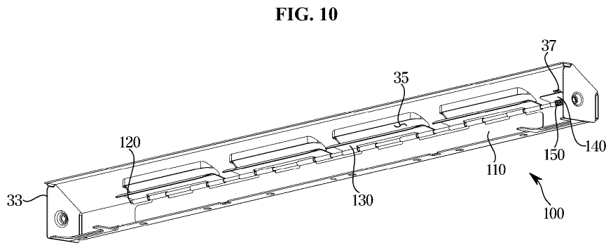

FIG. 9 shows a door locked state of a cooking apparatus according to an embodiment, and FIG. 10 shows a discharge hole opened by an opening/closing device of a cooking apparatus according to an embodiment.

Referring to FIGS. 9 and 10, according to the door locking device 60 being locked to the locking portion 37 and the door locking switch 61 pressing the contact portion 140, the cover 130 may rotate on the rotating shaft 120. While the cover 130 rotates, the cover 130 may be converted from a closed state to an open state. Accordingly, the discharge hole 35 of the door duct 33 may be converted from a closed state to an open state. That is, according to the door locking device 60 locking the door 30, the door locking device 60 may contact the contact portion 140, the rotating shaft 120 may rotate, and the cover 130 may rotate together with the rotating shaft 120 to open the discharge hole 35.

Also, when a force from the door locking switch 61 pressing the contact portion 140 is released, the cover 130 may rotate to an original (initial) position before rotation by the torsion spring 150. Accordingly, the discharge hole 35 of the door duct 33 may be converted from the open state to the closed state. That is, according to the door locking device 60 unlocking the door 30, the door locking device 60 may be released from the contact portion 10, the rotating shaft 120 may rotate to a position before rotation by the torsion spring, and the cover 130 may rotate together with the rotating shaft 120 to close the discharge hole 35.

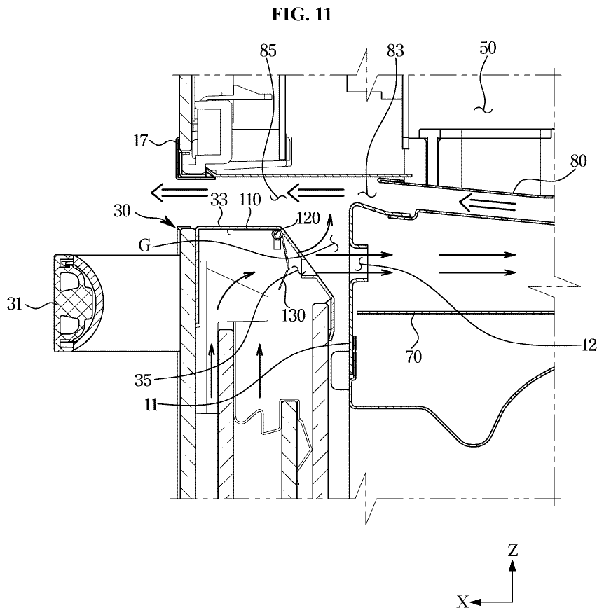

FIG. 11 shows a flow of air by which high-temperature air inside a door is discharged to outside of a cooking apparatus according to an embodiment while a discharge hole is opened by an opening/closing device of the cooking apparatus.

FIG. 11 shows a state in which the door locking switch 61 is locked to the locking portion 37 while the cooking apparatus 1 operates. In this case, the door locking switch 61 may contact the contact portion 140 and press the contact portion 140. Therefore, the cover 130 may rotate. According to the rotation of the cover 130, the discharge hole 35 of the door duct 33 may open.

While the discharge hole 35 is in an open state, high-temperature air inside the door 30 may be discharged to the outside of the door 30 through the discharge hole 35. A part of the high-temperature air discharged to the discharge hole 35 may be sucked into the inlet hole 12 by the cooling fan 51. The high-temperature air sucked into the inlet hole 12 may be guided by the inlet duct 70 and sucked into the cooling fan 51 through the inlet opening 81. The high-temperature air sucked into the cooling fan 51 may be discharged to the outside of the cooking apparatus 1 through the exhaust passages 80 and 85.

The remaining part of the high-temperature air discharged to the discharge hole 35 may be discharged to the exhaust portion 85 through the gap G. This may be performed by the Venturi effect caused by a flow rate of air that is sucked into the machine room 50 by the cooling fan 51, then guided by the exhaust passages 80 and 85, and discharged from the cooking apparatus 1 in the front direction.

Accordingly, high-temperature air inside the door 30 may be discharged to the outside of the cooking apparatus 1 through at least one of a method based on the Venturi effect or a method based on forced suction by the cooling fan 51. Therefore, a temperature of the outer surface of the cooking room 20 may be lowered as much as possible.

Thereafter, as shown in FIG. 8, the door locking switch 61 may be unlocked from the locking portion 37 according to a temperature of the cooking room 20 while the cooking apparatus 1 operates. In this case, the door locking switch 61 may be spaced from the contact portion 140 and a force pressing the contact portion 140 may be released. When the force pressing the contact portion 140 is released, the cover 130 may rotate to the original position before rotation by the torsion spring. According to the cover 130 rotating to the original position before rotation, the cover 130 may close the discharge hole 35.

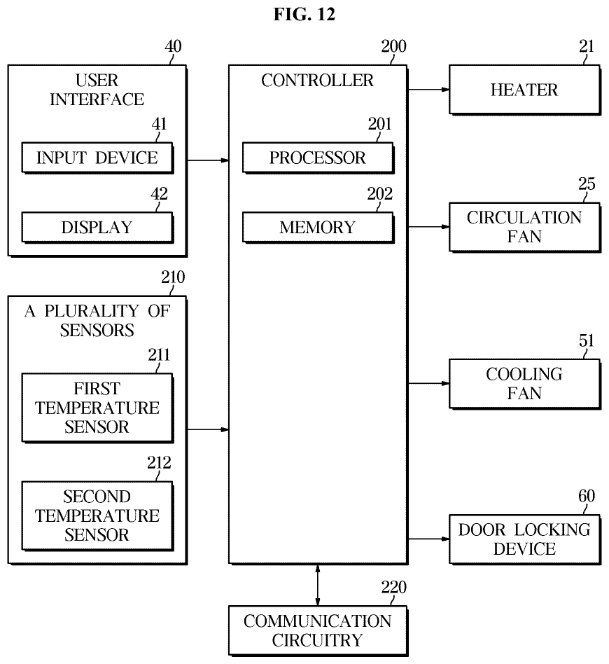

FIG. 12 is a control block diagram of a cooking apparatus according to an embodiment.

Referring to FIG. 12, the cooking apparatus 1 may include the heater 21, the user interface 40, the circulation fan 25, the cooling fan 51, the door locking device 60, a a plurality of sensors 210, a communication circuitry 220, and/or a controller 200. The controller 200 may be electrically connected to components of the cooking apparatus 1 and control the components of the cooking apparatus 1.

The user interface 40 may enable a user to interact with the cooking apparatus 1.

The user interface 40 may include the input device 41 and the display 42.

The input device 41 may receive a user input.

The input device 41 may include a start/select button, a dial, a stop/cancel button, an auto-cook button, a cleaning button and/or dial, etc.

The start/select button may receive a command for selecting a setting selected by the dial and a command for starting cooking.

The stop/cancel button may receive a command for canceling a setting selected by the dial and a command for stopping cooking.

The auto-cook button may receive a command for inputting information about a cooking material. In the case in which a user is unsure about a recipe for cooking, the user may input information about a cooking material which he or she wants to cook through the auto-cook button.

The cleaning button may receive a command for cleaning inside of the cooking room 20.

According to various embodiments, the input device 41 may include the communication circuitry 220, in that user inputs may be received from an external device (e.g., a smartphone or a server) via the communication circuitry 220.

Each of the buttons and/or dials may include a visual indicator (e.g., text, an icon, etc.) capable of indicating a function.

Here, the terms, such as the button, the dial, etc., may be replaced with input devices in that the button, the dial, etc. receive a user input. Also, the input devices, such as the button, the dial, etc., may be replaced with various types of input devices.

For example, the button or dial may be replaced with a User Interface (UI) element, a tact switch, a push switch, a slide switch, a toggle switch, a micro switch, a touch switch, a touch pad, a touch screen, a jog dial, and/or a microphone.

The input device 41 may include, for example, a tact switch, a push switch, a slide switch, a toggle switch, a micro switch, a touch switch, a touch pad, a touch screen, a jog dial, and/or a microphone.

The display 42 may generate sensory information and transfer various information related to operations of the cooking apparatus 1 to a user.

For example, the display 42 may transfer information related to an operation time of the cooking apparatus 1 and settings of the cooking apparatus 1 to the user. Information related to an operation of the cooking apparatus 1 may be output through a display, an indicator, a voice, etc. The display 42 may include, for example, a Liquid Crystal Display (LCD) panel, an indicator, a Light Emitting Diode (LED) panel, a speaker, etc.

The display 42 may display information related to an operation of the cooking apparatus 1. The display 42 may display information input by a user or information that is to be provided to a user through various screens.

The user interface 40 may receive a user input of selecting a cooking course and/or a cleaning course.

The controller 200 may process a command received through the input device 41 to control an operation of the cooking apparatus 1.

The heater 21 may heat air of the cooking room 20.

The heater 21 may include a light wave heater and/or an electric heater.

The controller 200 may control operations of the heater 21.

For example, the controller 200 may turn on the heater 21. The controller 200 may turn off the heater 21. The controller 200 may control on/off of the heater 21.

Turning on the heater 21 may include switching the heater 21 in an off state to an on state.

Turning off the heater 21 may include switching the heater 21 in an on state or under on/off control to an off state.

On/off control of the heater 21 may include repeatedly controlling on/off of the heater 120 to achieve a preset purpose (e.g., maintaining a temperature of the cooking room 20).

According to various embodiments, the controller 200 may adjust a heating level and a heating time of the heater 21 according to the kind, number, size, and cooking course of cooking materials and/or a cleaning course.

The circulation fan 25 may circulate air of the cooking room 20.

The circulation fan 25 may also be referred to as a convection fan 25 in that the circulation fan 25 transfers air heated by the heater 21 to a cooking material through a convection phenomenon. According to air inside the cooking room 20 being circulated by the convection fan 25, heat generated by the heater 21 may be uniformly transferred inside the cooking room 20.

The cooling fan 51 may discharge sucked high-temperature air to the outside of the cooking apparatus 1. The cooling fan 51 may suck in high-temperature air inside the door 30 and discharge the sucked high-temperature air to the outside of the main body 10.

The controller 200 may control an operation of the circulation fan 25 and/or the cooling fan 51.

For example, the controller 200 may turn on the circulation fan 25 and/or the cooling fan 51. The controller 200 may turn off the circulation fan 25 and/or the cooling fan 51.

Turning on the circulation fan 25 and/or the cooling fan 51 may include switching the circulation fan 25 and/or the cooling fan 51 in an off state to an on state.

Turning off the circulation fan 25 and/or the cooling fan 51 may include switching the circulation fan 25 and/or the cooling fan 51 in an on state to an off state.

According to various embodiments, the controller 200 may adjust RPM and a rotating time of the circulation fan 25 and/or the cooling fan 51 according to the kind, number, size, and cooking course of a cooking material and/or a cleaning course.

The plurality of sensors 210 may collect information related to the cooking apparatus 1.

The plurality of sensors 210 may include a first temperature sensor 211 that detects a temperature of the cooking room 20.

The first temperature sensor 211 may be referred to as a room sensor 211.

The first temperature sensor 211 may be installed at various locations inside the main body 10.

The first temperature sensor 211 may be installed in the door 30 to detect a temperature of the door 30. In this case, the first temperature sensor 211 may be referred to as a door sensor 211.

The first temperature sensor 211 may transfer an electrical signal corresponding to a detected temperature to the controller 200. The controller 200 may control at least one of the heater 21, the circulation fan 25, the cooling fan 25, or the door locking device 60 based on the temperature detected by the first temperature sensor 211.

The plurality of sensors 210 may include a second temperature sensor 212 that detects a temperature of a PCB on which the controller 200 is mounted or a PBA including the PCB. The second temperature sensor 212 may include a Negative Temperature Coefficient (NTC) thermistor.

The second temperature sensor 212 may detect a temperature of the machine room 50 that accommodates the PCB or PBA. The PCB or PBA may be provided in the machine room 50 located above the cooking room 20.

According to various embodiments, the plurality of sensors 70 may include both the first temperature sensor 211 and the second temperature sensor 212 or only the first temperature sensor 211.

The door locking device 60 may lock or unlock the door 30.

The door locking device 60 may include the door locking switch 61 that is rotatable relative to the door locking device 60, and the door locking motor 62 that rotates the door locking switch 61.

The controller 200 may control operations of the door locking device 60.

The controller 200 may turn on the door locking device 60. The controller 200 may turn off the door locking device 60.

Turning on the door locking device 60 may include switching the door locking device 60 in an off state to an on state. Turning on the door locking device 60 may include rotating the door locking switch 61 in one direction through the motor locking motor 62 to couple the door locking switch 61 to the locking portion 37, thereby switching an unlocked state of the door 30 to a locked state.

Turning off the door locking device 60 may include switching the door locking device 60 in an on state to an off state. Turning off the door locking device 60 may include rotating the door locking switch 61 in the opposite direction through the motor locking motor 62 to separate the door locking switch 61 from the locking portion 37, thereby switching a locked state of the door 30 to an unlocked state.

The controller 200 may open or close the discharge hole 35 of the door duct 33 through the door locking device 60. The controller 200 may open or close the discharge hole 35 of the door duct 33 by interworking with a door locking operation or a door unlocking operation of the door locking device 60. For example, the controller 200 may open the discharge hole 35 of the door duct 33 by interworking with a door locking operation of the door locking device 60. The controller 200 may close the discharge hole 35 of the door duct 33 by interworking with a door unlocking operation of the door locking device 60.

Also, in the case in which the opening/closing device 100 itself opens or closes the discharge hole 35 of the door duct 33, the controller 200 may itself open or close the discharge hole 35 of the door duct 33 through the opening/closing device 100.

According to various embodiments, the controller 200 may control an operation of the door locking device 60 according to a temperature of the cooking room 20 and/or an operation course (a cooking course or a cleaning course).

The communication circuitry 220 may communicate with an external device (e.g., a server, a user device, and/or a home appliance) by wire or wirelessly.

The communication circuitry 220 may include at least one of a short-range wireless communication module or a long-distance wireless communication module.

The communication circuitry 220 may transmit data to an external device or receive data from an external device. For example, the communication circuitry 220 may establish communication with a server, and/or a user terminal, and/or another home appliance to transmit or receive various data.

To this end, the communication circuitry 220 may establish a direct (wired) communication channel or a wireless communication channel with an external device and support communication through the established communication channel. According to an embodiment, the communication circuitry 220 may include a wireless communication module (for example, a cellular communication module, a short-range wireless communication module, or a global navigation satellite system (GNSS) communication module), or a wired communication module (for example, a local area network (LAN) communication module or a power line communication module). A corresponding communication module among the communication modules may communicate with an external device through a first network (for example, a short-range wireless communication network, such as Bluetooth, wireless fidelity (WiFi) direct, or infrared data association (IrDA)) or a second network (for example, a long-distance wireless communication network, such as a legacy cellular network, a 5G network, a next-generation communication network, the Internet, or a computer network (for example, a local area network (LAN) or a wide area network (WAN)). Such various kinds of communication modules may be integrated into a component (for example, a single chip) or implemented as a plurality of independent components (for example, a plurality of chips).

The short-range wireless communication module may include, but is not limited to, a Bluetooth communication module, a Bluetooth Low Energy (BLE) communication module, a Near Field Communication (NFC) communication module, a Wireless Local Area Network (WLAN; WiFi) communication module, a Zigbee communication module, an IrDA communication module, a Wi-Fi Direct (WFD) communication module, a Ultrawideband (UWB) communication module, an Ant+ communication module, a microwave (uWave) communication module, etc.

The long-distance wireless communication module may include a communication module that performs various kinds of long-distance communications and may include a mobile communication circuitry. The mobile communication circuitry may transmit/receive a wireless signal to/from at least one of a base station, an external terminal, or a server on a mobile communication network.

According to an embodiment, the communication circuitry 220 may communicate with an external device, such as a server, a user device, another home appliance, etc., through a surrounding Access Point (AP). The AP may connect a LAN to which the cooking apparatus 1, another home appliance, and/or a user device is connected to a WAN to which a server is connected. The cooking apparatus 1, the other home appliance, and/or the user device may be connected to the server through the WAN.

The controller 200 may receive information from an external device through the communication circuitry 220. The controller 200 may receive a command for controlling the cooking apparatus 1 from the external device through the communication circuitry 220. The controller 200 may receive information about a cooking material from the external device through the communication circuitry 220.

The controller 200 may include a processor 201 and a memory 202. The processor 201 may include a logic circuit and an arithmetic circuit, as hardware. The processor 201 may control components of the cooking apparatus 1, which are electrically connected to each other, by using a program, an instruction, and/or data stored in the memory 202 for operations of the cooking apparatus 1. The controller 200 may be implemented as a control circuit including a circuit element, such as a capacitor, an inductor, and a resistor. The processor 201 and memory 202 may be implemented as separate chips or a single chip. Also, the controller 200 may include a plurality of processors and a plurality of memories.

The memory 202 may store a program, an application, and/or data for operations of the cooking apparatus 1 and store data generated by the processor 201. The memory 202 may include a non-volatile memory, such as Read Only Memory (ROM) and a flash memory, for storing data for a long time. The memory 202 may include a volatile memory, such as Static Random Access Memory (S-RAM) and Dynamic Random Access Memory (DRAM), for temporarily memorizing data.

In an embodiment, the controller 200 may control various components of the cooking apparatus 1 according to various cooking courses.

The controller 200 may detect a temperature of the cooking room 20 through the first temperature sensor 211, open the discharge hole 35 of the door duct 33 based on the temperature of the cooking room 20 being higher than or equal to a preset temperature, and close the open discharge hole 35 based on the temperature of the cooking room 20 being lower than the preset temperature.

Components of the cooking apparatus 1 are not limited to the above-described components. The cooking apparatus 1 may further include various components in addition to the above-described components, and some of the above-described components may be omitted.

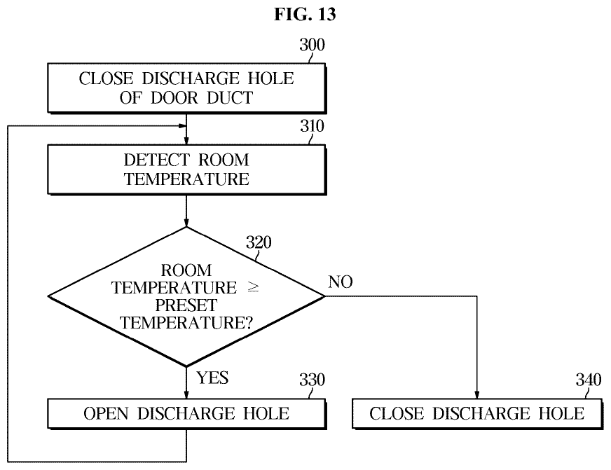

FIG. 13 shows an example of a flowchart illustrating a method of controlling a cooking apparatus according to an embodiment.

Referring to FIG. 13, the controller 200 may close the discharge hole 35 of the door duct 33 at beginning of an operation of the cooking apparatus 1 (300).

The controller 200 may maintain the door locking device 60 in an off state such that the discharge hole 35 of the door duct 33 maintains a closed state which is an initial state. The initial state of the discharge hole 35 of the door duct 33 may be a closed state. The controller 200 may unlock the door locking device 60 from the locking portion 37 to space the door locking switch 61 from the contact portion 140, thereby maintaining the discharge hole 35 of the door duct 33 in the closed state which is the initial state.

The controller 200 may detect a temperature (room temperature) of the cooking room 20 through the first temperature sensor 211 (310).

The controller 200 may identify whether the room temperature is a preset temperature or higher (320).

According to the room temperature being higher than or equal to the preset temperature (YES in 320), the controller 200 may open the discharge hole 35 of the door duct 33 (330). The controller 200 may turn on the door locking device 60 based on the room temperature being higher than or equal to the preset temperature. According to the turning-on of the door locking device 60, the door locking switch 61 may rotate in one direction by the door locking motor 62 and be caught by the locking portion 37. According to the door locking switch 61 being caught by the locking device 37, the door locking switch 61 may contact the contact portion 140 of the opening/closing device 100. The door locking switch 61 may contact the contact portion 140 and push the contact portion 140 to rotate the contact portion 140. While the contact portion 140 rotates, the cover 130 closing the discharge hole 35 of the door duct 33 may rotate on the rotating shaft 120. According to the rotation of the cover 130, the discharge hole 35 may open.

Accordingly, high-temperature air inside the door 30 may be discharged to the outside of the door 30 through the discharge hole 35. A part of the high-temperature air discharged through the discharge hole 35 may be sucked into the inlet hole 12 by the cooling fan 51. The high-temperature air sucked into the inlet hole 12 may be guided by the inlet duct 70 and sucked into the cooling fan 51 through the inlet opening 81. The high-temperature air sucked into the cooling fan 51 may be discharged to the outside of the cooking apparatus 1 through the exhaust passages 80 and 85. The remaining part of the high-temperature air discharged to the discharge hole 35 may be discharged to the exhaust portion 85 through the gap G. As such, high-temperature air inside the door 30 may be discharged to the outside of the cooking apparatus 1 through at least one of a method based on the Venturi effect or a method based on forced suction by the cooling fan 51. Therefore, a surface temperature of the outer surface of the door 30 may be lowered as much as possible.

Also, according to the room temperature being lower than the preset temperature (NO in 320), the controller 200 may close the discharge hole 35 of the door duct 33 (340).

When the room temperature drops from a level of the preset temperature or higher to a level lower than the preset temperature, the controller 200 may switch the door lock device 60 from an on state to an off state. According to turning-off of the door locking device 60, the door locking switch 61 may rotate in the opposite direction by the door locking motor 62 and be unlocked from the locking portion 37. According to the door locking switch 61 being unlocked from the locking portion 37, a force pressing the contact portion 140 of the opening/closing device 100 may be removed and the cover 130 may return to the original position by the torsion spring 150. According to the cover 150 returning to the original position, the open discharge hole 35 may be closed by the cover 130 returned.

Accordingly, high-temperature air inside the door 30 may be prevented from being discharged to the outside of the door 30. Therefore, because high-temperature air inside the door 30 is prevented from being discharged to the outside of the door 30, energy loss may be reduced.

As described above, when a temperature of the cooking room 20 is high, the door 30 may be locked by operating the opening/closing device 100 through the door locking device 60 and high-temperature air inside the door 30 may be discharged to the outside of the door 30 by opening the discharge hole 35 of the door duct 33, thereby lowering a surface temperature of the door 30. Also, when a temperature of the cooking room 20 is low, the door 30 may be unlocked by operating the opening/closing device 100 through the door locking device 60 and high-temperature air inside the door 30 may be prevented from being discharged to the outside of the door 30 by closing the discharge hole 35 of the door duct 33, thereby reducing energy loss inside the door 30.

Accordingly, in a situation in which a surface temperature of the door 30 needs to be lowered due to a relatively high temperature of the cooking room 20, the discharge hole 35 may open to lower the surface temperature of the door 30, and in a situation in which energy loss of the door 30 needs to be reduced due to a relatively low temperature of the cooking room 20, the discharge hole 35 may be closed to improve insulation of the door duct 33, thereby reducing energy loss inside the glasses of the door 30 to save energy and achieving even cooking.

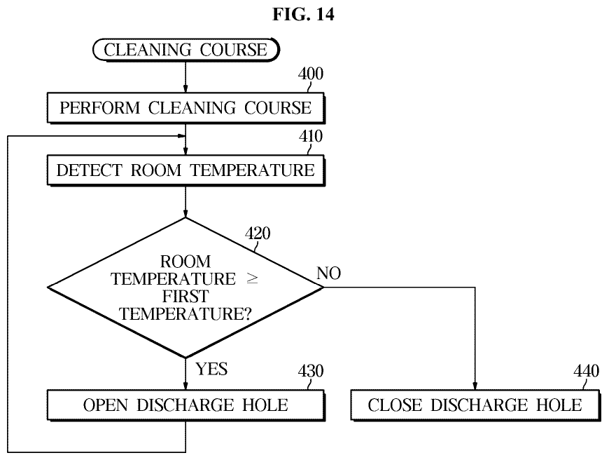

FIG. 14 shows an example of a flowchart illustrating a method of opening or closing a discharge hole of a door duct based on a temperature of a cooking room in a cleaning course of a cooking apparatus according to an embodiment.

Referring to FIG. 14, an initial state of the discharge hole 35 of the door duct 33 of the cooking apparatus 1 may be a closed state.

The controller 200 may perform a cleaning course (400).

The controller 200 may receive a user input of selecting a cooking course or a cleaning course through the user interface 40. The controller 200 may perform the cleaning course based on the user input. The controller 200 may perform the cleaning course based on a user's selection of the cleaning course.

The cleaning course may include a Pyrolytic clean course of driving the heater 21 that supplies heat to the inside of the cooking room 20. For example, the Pyrolytic clean course may burn contaminants in the cooking room 20 by driving the heater 21 to heat the cooking room 20 at 450°C or higher.

The controller 200 may perform the Pyrolytic clean course by driving the heater 21. The controller 200 may perform the Pyrolytic clean course by driving the heater 21 and the circulation fan 25. The controller 200 may perform the Pyrolytic clean course by driving the heater 21, the circulation fan 25, and the cooling fan 51.

The controller 200 may detect a temperature (room temperature) of the cooking room 20 through the first temperature sensor 211 (410).

The controller 200 may identify whether the room temperature is a first temperature or higher (420).

According to the room temperature being higher than or equal to the first temperature (YES in 420), the controller 200 may open the discharge hole 35 of the door duct 33 (430). Also, in response to a start of a cleaning course, the controller 200 may open the discharge hole 35 of the door duct 33 regardless of an internal temperature of the cooking room 20. For example, according to a room temperature exceeding 270 °C, the controller 200 may open the discharge hole 35.

Based on the room temperature being higher than or equal to the first temperature, the controller 200 may turn on the door locking device 60. According to the turning-on of the door locking device 60, the door locking switch 61 may rotate in one direction by the door locking motor 62 and be caught by the locking portion 37. According to the door locking switch 61 being caught by the locking portion 37, the door locking switch 61 may contact the contact portion 140 of the opening/closing device 100. The door locking switch 61 may contact the contact portion 140 and push the contact portion 140 to rotate the contact portion 140. While the contact portion 140 rotates, the cover 130 may rotate on the rotating shaft 120. According to the rotation of the cover 130, the discharge hole 35 may open.

Accordingly, high-temperature air inside the door 30 may be discharged to the outside of the door 30 through the discharge hole 35. A part of the high-temperature air discharged through the discharge hole 35 may be sucked into the inlet hole 12 by the cooling fan 51. The high-temperature air sucked into the inlet hole 12 may be guided by the inlet duct 70 and sucked into the cooling fan 51 through the inlet opening 81. The high-temperature air sucked into the cooling fan 51 may be discharged to the outside of the cooking apparatus 1 through the exhaust passages 80 and 85. The remaining part of the high-temperature air discharged to the discharge hole 35 may be discharged to the exhaust portion 85 through the gap G. Therefore, a surface temperature of the outer surface of the door 30 may be lowered.

Also, according to the room temperature being lower than the first temperature (NO in 420), the controller 200 may close the discharge hole 35 of the door duct 33 (440). For example, according to a room temperature being lowered from a temperature of 270 °C or higher to a temperature lower than 270 °C, the controller 200 may close the discharge hole 35.

According to the room temperature being lowered from a level of the first temperature or higher to a level lower than the first temperature, the controller 200 may switch the door locking device 60 from an on state to an off state. According to turning-off of the door locking device 60, the door locking switch 61 may rotate in the opposite direction by the door locking motor 62 and be unlocked from the locking portion 37. According to the door locking switch 61 being unlocked from the locking portion 37, a force pressing the contact portion 140 of the opening/closing device 100 may be removed and the cover 130 may return to the original position by the torsion spring 150. According to the cover 130 returning to the original position, the open discharge hole 35 may be closed.

Accordingly, high-temperature air inside the door 30 may be prevented from being discharged to the outside of the door 30. Therefore, because high-temperature air inside the door 30 is prevented from being discharged to the outside of the door 30, energy loss may be reduced.

As described above, when a temperature of the cooking room 20 is high in a cleaning course, the opening/closing device 100 may operate through the door locking device 60 to open the discharge hole 35 of the door duct 33 while locking the door 30, thereby discharging high-temperature air inside the door 30 to the outside of the door 30 to lower a surface temperature of the door 30. Also, when a temperature of the cooking room 20 is low in a cleaning course, the opening/closing device 100 may operate through the door locking device 60 to close the discharge hole 35 of the door duct 33 while unlocking the door 30, thereby preventing high-temperature air inside the door 30 from being discharged to the outside of the door 30 to reduce energy loss inside the door 30.

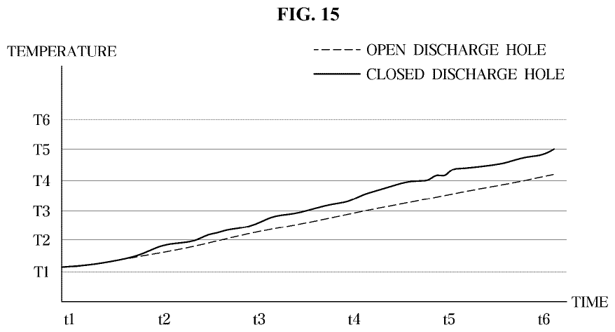

FIG. 15 shows changes in room temperature while a discharge hole of a door duct is opened/closed in a cooking apparatus according to an embodiment.

Referring to FIG. 15, a horizonal axis in a graph represents a time and a vertical axis represents a temperature of the cooking room 20.

It is seen that a room temperature while the discharge hole 35 of the door duct 33 is closed is higher than a room temperature while the discharge hole 35 opens. According to elapse of time, a difference between the room temperatures may become greater.

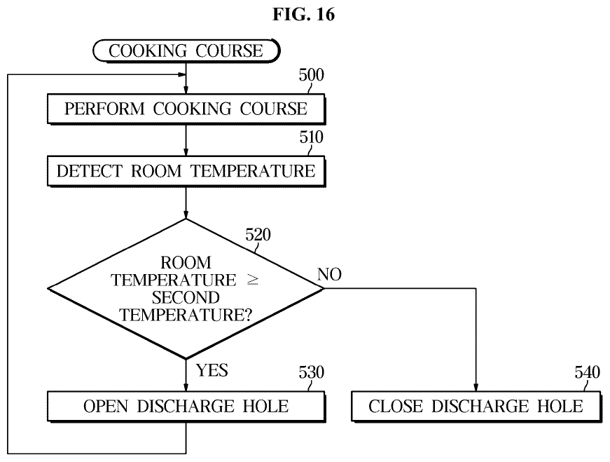

FIG. 16 shows an example of a flowchart illustrating a method of opening or closing a discharge hole of a door duct based on a temperature of a cooking room in a cooking course of a cooking apparatus according to an embodiment.

Referring to FIG. 16, an initial state of the discharge hole 35 of the door duct 33 of the cooking apparatus 1 may be a closed state.

The controller 200 may perform a cooking course (500).

The controller 200 may receive a user input corresponding to a cooking course through the user interface 40. The controller 200 may perform the cooking course based on the received user input. The controller 200 may perform a cooking course based on the cooking course being selected by a user.

The cooking course may include a course of cooking a cooking material inside the cooking room 20. For example, the cooking course may include a quick defrost course, an air fry course, a steaming course, etc.

The controller 200 may perform the cooking course by driving the heater 21 and the circulation fan 25. The controller 200 may perform the cooking course by driving the heater 21, the circulation fan 25, and the cooling fan 51.

The controller 200 may detect a temperature (room temperature) of the cooking room 20 through the first temperature sensor 211 (510).

The controller 200 may identify whether the room temperature is a second temperature or higher (520).

According to the room temperature being higher than or equal to the second temperature (YES in 520), the controller 200 may open the discharge hole 35 of the door duct 33 (530). For example, according to a room temperature exceeding 310 °C, the controller 200 may open the discharge hole 35.

The controller 200 may turn on the door locking device 60 based on the room temperature being higher than or equal to the second temperature. According to the turning-on of the door locking device 60, the door locking switch 61 may rotate in one direction by the door locking motor 62 and be caught by the locking portion 37. According to the door locking switch 61 being caught by the locking portion 37, the door locking switch 61 may contact the contact portion 140 of the opening/closing device 100. The door locking switch 61 may contact the contact portion 140 and push the contact portion 140 to rotate the contact portion 140. According to the rotation of the contact portion 140, the cover 130 may rotate on the rotating shaft 120. According to the rotation of the cover 130, the discharge hole 35 may open.

Accordingly, high-temperature air inside the door 30 may be discharged to the outside of the door 30 through the discharge hole 35. A part of the high-temperature air discharged through the discharge hole 35 may be sucked into the inlet hole 12 by the cooling fan 51. The high-temperature air sucked into the inlet hole 12 may be guided by the inlet duct 70 and sucked into the cooling fan 51 through the inlet opening 81. The high-temperature air sucked into the cooling fan 51 may be discharged to the outside of the cooking apparatus 1 through the exhaust passages 80 and 85. The remaining part of the high-temperature air discharged to the discharge hole 35 may be discharged to the exhaust portion 85 through the gap G. Therefore, a surface temperature of the outer surface of the door 30 may be lowered.

According to the room temperature being lower than the second temperature (NO in 520), the controller 200 may close the discharge hole 35 of the door duct 33 (540). For example, when the room temperature drops from a temperature of 310 °C or higher to a temperature lower than 310 °C, the controller 200 may close the discharge hole 35. Also, when the room temperature drops from a temperature of 310 °C or higher to a temperature lower than 270 °C, the controller 200 may close the discharge hole 35.

When the room temperature drops from a level of the second temperature or higher to a level lower than the second temperature, the controller 200 may switch the door locking device 60 from an on state to an off state. According to turning-off of the door locking device 60, the door locking switch 61 may rotate in the opposite direction by the door locking motor 62 and be unlocked from the locking portion 37. According to the door locking switch 61 being unlocked from the locking portion 37, a force pressing the contact portion 140 of the opening/closing device 100 may be removed and the cover 130 may return to the original position by the torsion spring 150. According to the cover 150 returning to the original position, the open discharge hole 35 may be closed.

Accordingly, high-temperature air inside the door 30 may be prevented from being discharged to the outside of the door 30. Therefore, because high-temperature air inside the door 30 is prevented from being discharged to the outside of the door 30, energy loss may be reduced.

As described above, when a temperature of the cooking room 20 is high in a cooking course, the door 30 may be locked by operating the opening/closing device 100 through the door locking device 60 and high-temperature air inside the door 30 may be discharged to the outside of the door 30 by opening the discharge hole 35 of the door duct 33, thereby lowering a surface temperature of the door 30. Also, when a temperature of the cooking room 20 is low in the cooking course, the door 30 may be unlocked by operating the opening/closing device 100 through the door locking device 60 and high-temperature air inside the door 30 may be prevented from being discharged to the outside of the door 30 by closing the discharge hole 35 of the door duct 33, thereby reducing energy loss inside the door 30.

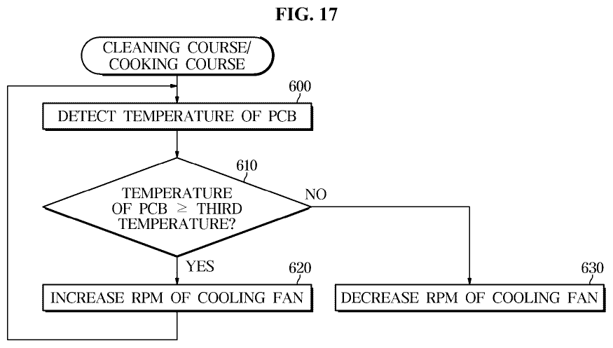

FIG. 17 shows an example of a flowchart illustrating a method of controlling RPM of a cooling fan based on a temperature of a PCB while a cooking apparatus according to an embodiment operates.

Referring to FIG. 17, while the cooking apparatus 1 performs a cleaning course or a cooking course, the controller 200 may detect, through the second temperature sensor 212, a temperature (PCB temperature) of the PCB which is positioned inside the machine room 50 above the cooking room 20 and on which the controller 200 is mounted (600).

The controller 200 may identify whether the temperature of the PCB is a third temperature or higher (610). For example, the third temperature may be 65 °C.

According to the temperature of the PCB being higher than or equal to the third temperature (YES in 610), the controller 200 may increase RPM of the cooling fan 51. For example, according to the temperature of the PCB being higher than or equal to 65 °C, the controller 200 may increase RPM of the cooling fan 51 to maximum RPM. At this time, the controller 200 may open the discharge hole 35 of the door duct 33.

According to the temperature of the PCB being lower than the third temperature (NO in 610), the controller 200 may decrease RPM of the cooling fan 51. For example, when the temperature of the PCB drops from a temperature of 65 °C or higher to a temperature lower than 65 °C, the controller 200 may decrease RPM of the cooling fan 51 to normal RPM. At this time, the controller 200 may close the discharge hole 35 of the door duct 33.

While the cooking apparatus 1 operates, a temperature of the cooking room 20 may rise, and simultaneously, a temperature of the PCB or PBA of the machine room 50 may also rise.

The temperature of the PCB or PBA may be proportional to a surface temperature of the door 30. When the temperature of the PCB or PBA rises to a specific temperature or higher, the cooling fan 51 may operate and the discharge hole 35 may open.

When a temperature of the PCB or PBA is high, RPM of the cooling fan 51 may be controlled to lower a surface temperature of the door 30.

High-temperature air discharged through the discharge hole 35 may be sucked into the inlet hole 12 by the cooling fan 51, and the high-temperature air sucked into the inlet hole 12 may be guided by the inlet duct 70 to be sucked into the cooling fan 51 through the inlet opening 81. The high-temperature air sucked into the cooling fan 51 may be discharged to the outside of the cooking apparatus 1 through the exhaust passages 80 and 85. Therefore, a surface temperature of the outer surface of the door 30 may be lowered.

According to the disclosure, when a temperature of the cooking room 20 is high, the opening/closing device 100 may operate through the door locking device 60 to open the discharge hole 35 of the door duct 33 while locking the door 30, thereby discharging high-temperature air inside the door 30 to the outside of the door 30 to lower a surface temperature of the door 30. Also, when a temperature of the cooking room 20 is low, the opening/closing device 100 may operate through the door locking device 60 to close the discharge hole 35 of the door duct 33 while unlocking the door 30, thereby preventing high-temperature air inside the door 30 from being discharged to the outside of the door 30 to reduce energy loss inside the door 30.

A cooking apparatus 1 according to an embodiment of the disclosure may include: a main body 10; a cooking room 20 provided inside the main body 10, wherein a front side of the cooking room 20 opens; a door 30 configured to open or close the cooking room 20; a door duct 33 including a discharge hole 35 through which air inside the door 30 is discharged to outside of the door 30; and a controller 200 configured to open the discharge hole 35 based on an internal temperature of the cooking room 20 being higher than or equal to a preset temperature and close the discharge hole 35 based on the internal temperature of the cooking room 20 being lower than the preset temperature.

The cooking apparatus 1 may further include: a door locking device 60 configured to lock or unlock the door 30; and an opening/closing device 100 configured to open the discharge hole 35 according to the door locking device 60 locking the door 30 and close the discharge hole 35 according to the door locking device 60 unlocking the door 30.

The controller 200 may be further configured to open the discharge hole 35 by controlling the door locking device 60 to lock the door 30 and close the discharge hole 35 by controlling the door locking device 60 to unlock the door 30.

The opening/closing device 100 may include a support 110 provided in the door duct 33, a rotating shaft 120 rotatably supported to the support 110, a cover 130 configured to rotate together with the rotating shaft 120 and open or close the discharge hole 35, a contact portion 140 provided in the rotation shaft 120 and configured to rotate the cover 130 by contacting or being released from the door locking device 60, and a torsion spring 150 provided in the contact portion 140.

According to the door locking device 60 locking the door 30, the door locking device 60 may contact the contact portion 140 to rotate the rotating shaft 120, and the cover 130 may rotate together with the rotating shaft 120 to open the discharge hole 35.

According to the door locking device 60 unlocking the door 30, the door locking device 60 may be released from the contact portion 140, the rotating shaft 120 may rotate to a position before the rotating shaft 120 rotates, by the torsion spring 150, and the cover 130 may rotate together with the rotating shaft 120 to close the discharge hole 35.

The controller 200 may be configured to, in a cleaning course, open the discharge hole 35 based on an internal temperature of the cooking room 29 being higher than or equal to a first temperature and close the discharge hole 35 based on the internal temperature of the cooking room 20 being lower than the first temperature, and, in a cooking course, open the discharge hole 35 based on an internal temperature of the cooking room 20 being higher than or equal to a second temperature and close the discharge hole 35 based on the internal temperature of the cooking room 20 being lower than the second temperature, wherein the first temperature may be different from the second temperature.

The second temperature may be higher than the first temperature.

The cooking apparatus 1 may further include a cooling fan configured to discharge air discharged to the discharge hole to outside of the main body 10, wherein the controller 200 may be mounted on a Printed Circuit Board (PCB), and the controller 200 may control Revolutions Per Minute (RPM) of the cooling fan based on a temperature of the PCB.

The controller 200 may be configured to increase RPM of the cooling fan based on the temperature of the PCB being higher than or equal to a preset temperature and decrease RPM of the cooling fan based on the temperature of the PCB being lower than the preset temperature.

An initial state of the discharge hole 35 of the door duct 33 may be a closed state.

The controller 200 may be configured to, in response to a start of a cleaning course, open the discharge hole 35 regardless of an internal temperature of the cooking room 20, and close the discharge hole 35 in response to the internal temperature of the cooking room 20 dropping from a level of the preset temperature or higher to a level lower than the preset temperature.

A method of controlling a cooking apparatus 1 according to an embodiment of the disclosure may include: detecting an internal temperature of a cooking room 20; based on the internal temperature of the cooking room 20 being higher than or equal to a preset temperature, opening a discharge hole 35 of a door duct 33 to discharge air inside the door 30 to outside of the door 30; and based on the internal temperature of the cooking room 20 being lower than the preset temperature, closing the discharge hole 35.

The cooking apparatus 1 may further include: a door locking device 60 configured to lock or unlock the door 30; and an opening/closing device 100 configured to open the discharge hole 35 according to the door locking device 60 locking the door 30 and close the discharge hole 35 according to the door locking device 60 unlocking the door 30, wherein the opening of the discharge hole 35 may include opening the discharge hole 35 by controlling the door locking device 60 to lock the door 30, and the closing of the discharge hole 35 may include closing the discharge hole 35 by controlling the door locking device 60 to unlock the door 30.

The opening/closing device 100 may include a support 110 provided in the door duct 33, a rotating shaft 120 rotatably supported to the support 110, a cover 130 configured to rotate together with the rotating shaft 120 and open or close the discharge hole 35, a contact portion 140 provided in the rotation shaft 120 and configured to rotate the cover 130 by contacting or being released from the door locking device 60, and a torsion spring 150 provided in the contact portion 140. The opening of the discharge hole 35 may include, according to the door locking device 60 locking the door 30, rotating the rotating shaft 120 by the door locking device 60 contacting the contact portion 140 and rotating the cover 130 together with the rotating shaft 120 to open the discharge hole 35.

The closing of the discharge hole 35 may include, according to the door locking device 60 unlocking the door 30, releasing the door locking device 60 from the contact portion 140, rotating the rotating shaft 120 to a position before the rotating shaft 120 rotates, by the torsion spring 150, and rotating the cover 130 together with the rotating shaft 120 to close the discharge hole 35.

The opening of the discharge hole 35 may include opening the discharge hole 35 based on an internal temperature of the cooking room 20 being higher than or equal to a first temperature in a cleaning course, and opening the discharge hole 35 based on an internal temperature of the cooking room 20 being higher than or equal to a second temperature in a cooking course, and the closing of the discharge hole 35 may include closing the discharge hole 35 based on an internal temperature of the cooking room 20 being lower than the first temperature in a cleaning course, and closing the discharge hole 35 based on an internal temperature of the cooking room 20 being lower than the second temperature in a cooking course, wherein the first temperature may be different from the second temperature.

The cooking apparatus 1 may further include a cooling fan configured to discharge air discharged to the discharge hole 35 to the outside of the main body 10, and the controller 200 may be mounted on a PCB and configured to detect a temperature of the PCB, increase RPM of the cooling fan based on the temperature of the PCB being higher than or equal to a preset temperature, and decrease RPM of the cooling fan based on the temperature of the PCB being lower than the preset temperature.

An initial state of the discharge hole 35 of the door duct 33 may be a closed state.

The opening of the discharge hole 35 may include, in response to a start of a cleaning course, opening the discharge hole 35 regardless of an internal temperature of the cooking room 20, and the closing of the discharge hole 35 may include closing the discharge hole 35 in response to the internal temperature of the cooking room 20 dropping from a level of the preset temperature or higher to a level lower than the preset temperature.

Meanwhile, the disclosed embodiments may be implemented in the form of a recording medium that stores instructions executable by a computer. The instructions may be stored in the form of a program code, and when executed by a processor, the instructions may create a program module to perform operations of the disclosed embodiments.

The computer-readable recording medium may include all kinds of recording media storing instructions that can be interpreted by a computer. For example, the computer-readable recording media may include Read Only Memory (ROM), Random Access Memory (RAM), a magnetic tape, a magnetic disc, flash memory, an optical data storage device, etc.

Also, the computer-readable recording medium may be provided in the form of a non-transitory storage medium, wherein the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment, the methods according to various embodiments disclosed in this document may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smart phones) directly. When distributed online, at least part of the computer program product (e.g., a downloadable app) may be temporarily generated or at least temporarily stored in the machine-readable storage medium, such as memory of the manufacturer's server, a server of the application store, or a relay server.

So far, the disclosed embodiments have been described with reference to the accompanying drawings. It will be apparent that those skilled in the art can make various modifications thereto without changing the technical spirit and essential features of the disclosure. Thus, it should be understood that the embodiments described above are merely for illustrative purposes and not for limitation purposes in all aspects

1. A cooking apparatus comprising:
a main body;
a cooking room inside the main body;
a door configured to open and close to respectively open and close the cooking room, the door including a door duct having a discharge hole through which air inside the door is dischargeable to outside of the door; and
a controller configured to:
based on an internal temperature of the cooking room being greater than or equal to a temperature, open the discharge hole such that the air inside the door is dischargeable to the outside of the door, and
based on the internal temperature being less than the temperature, close the discharge hole such that the air inside the door is prevented from being discharged to the outside of the door.

2. The cooking apparatus of claim 1, further comprising:
a door locking device configured to lock and unlock the door; and
an opening/closing device configured to:
with the door locked by the door locking device, open the discharge hole, and
with the door unlocked by the door locking device, close the discharge hole.

3. The cooking apparatus of claim 2, wherein
the controller is further configured to:
control the door locking device to lock the door such that the opening/closing device opens the discharge hole, and
control the door locking device to unlock the door such that the opening/closing device closes the discharge hole.

4. The cooking apparatus of claim 2, wherein
the opening/closing device includes:
a support in the door duct,
a shaft that is rotatable and is supported by the support,
a cover configured to rotate together with the shaft to open the discharge hole and to close the discharge hole,
a contact portion on the shaft and configured to rotate the cover based on being contacted by, or spaced apart from, the door locking device, and
a torsion spring configured to, with the door locking device spaced apart from the contact portion, rotate the contact portion such that the discharge hole is closed by the cover.

5. The cooking apparatus of claim 4, wherein
with the door locked by the door locking device, the door locking device contacts the contact portion such that the shaft and the cover are rotated together to open the discharge hole.

6. The cooking apparatus of claim 4, wherein
with the door unlocked by the door locking device, the door locking device is spaced apart from the contact portion such that the shaft and the cover are rotated together by the torsion spring to close the discharge hole.

7. The cooking apparatus of claim 1, wherein
the controller is further configured to:
during a cleaning course,
based on the internal temperature of the cooking room being greater than or equal to a first temperature, open the discharge hole, and
based on the internal temperature of the cooking room being less than the first temperature, close the discharge hole, and,
during a cooking course,
based on the internal temperature of the cooking room being greater than or equal to a second temperature, open the discharge hole, and
based on the internal temperature of the cooking room being less than the second temperature, close the discharge hole, and
the first temperature is different from the second temperature.

8. The cooking apparatus of claim 7, wherein the second temperature is greater than the first temperature.

9. The cooking apparatus of claim 1, further comprising:
a cooling fan configured to, with the discharge hole open and the air inside the door discharged through the discharge hole, discharge the discharged air to the outside of the main body,
wherein the controller is mounted on a Printed Circuit Board (PCB), and
the controller is further configured to:
based on a temperature of the PCB, control Revolutions Per Minute (RPM) of the cooling fan.

10. The cooking apparatus of claim 9, wherein
the controller is further configured to:
based on the temperature of the PCB being greater than or equal to a first temperature, increase RPM of the cooling fan, and
based on the temperature of the PCB being less than the first temperature, decrease RPM of the cooling fan.

11. The cooking apparatus of claim 1, wherein an initial state of the discharge hole is a closed state.

12. The cooking apparatus of claim 1, wherein
the controller is further configured to:
in response to a start of a cleaning course,
open the discharge hole regardless of the internal temperature of the cooking room, and
close the discharge hole in response to the internal temperature of the cooking room dropping to or below the temperature.

13. A method of controlling a cooking apparatus including a main body, a cooking room inside the main body, a door configured to open and close to respectively open and close the cooking room, the door including a door duct having a discharge hole through which air inside the door is dischargeable to outside of the door, and a controller, the method comprising:
by the controller,
detecting an internal temperature of the cooking room,
based on the internal temperature being greater than or equal to a temperature, opening the discharge hole such that the air inside the door is dischargeable to the outside of the door, and
based on the internal temperature being less than the temperature, closing the discharge hole such that the air inside the door is prevented from being discharged to the outside of the door.

14. The method of claim 13, wherein
the cooking apparatus further includes:
a door locking device configured to lock and unlock the door, and
an opening/closing device configured to:
with the door locked by the door locking device, open the discharge hole, and
with the door unlocked by the door locking device, close the discharge hole,
the opening the discharge hole includes controlling the door locking device to lock the door such that the discharge hole is opened, and
the closing the discharge hole includes controlling the door locking device to unlock the door such that the discharge hole is closed.

15. The method of claim 14, wherein
the opening/closing device includes:
a support in the door duct,
a shaft that is rotatable and is supported by the support,
a cover configured to rotate together with the shaft to open the discharge hole and close the discharge hole,
a contact portion on the shaft and configured to rotate the cover based on being contacted by, or spaced apart from, the door locking device, and
a torsion spring configured to, with the door locking device spaced apart from the contact portion, rotate the contact portion such that the discharge hole is closed by the cover, and
the opening of the discharge hole includes:
with the door locking device locking the door and thereby contacting the contact portion, by the door locking device contacting the contact portion, rotating the shaft and the cover together to open the discharge hole.
